(19) United States
(12) Patent Application Publication
(10) Pub. No.: US 2014/0346978 A1
(43) Pub. Date: Nov. 27, 2014

(54) Light Emitting Surface

(71) Applicant: Vizio Inc., Irvine, CA (US)

(72) Inventor: Matthew McRae, Irvine, CA (US)

(21) Appl. No.: 13/900,293

(22) Filed: May 22, 2013

(51) Int. Cl. H05B 33/08

(52) U.S. Cl. CPC H05B 33/08
USPC 315/363

(57) ABSTRACT

An electronic device whose housing can be electronically changed in look. The housing can have at least one curved surface, an electronic device, in the housing, the electronic device carrying out a function and displaying information. The housing has a controllable color portion on the outer surface. That color portion is controlled to display its color.

### BACKGROUND

The life span of consumer products may be extended by what is referred to as the industrial design or ID of the product. Color preferences for products such as house hold appliances are one example of an item that becomes popular or unpopular over time. Colors that are popular one year become outdated several years after the product release to the market place. Appliances may be replaced simply because of their original color. This was evident, for example when kitchen appliances that were gold colored with accent shading became outdated within a short time when avocado colors became popular.

Electronic devices such as televisions, stereo equipment, hand held devices such as cell phones and PDAs can also become outdated because of the color of the device and the changing of color and position of indicators, buttons and other visual aspects of the device is changed.

The advent of Field-Induced polymer Electro Luminescent or FIPEL devices developed at Wake Forest University has been progressing beyond simple light panels able to replace incandescent, florescent, LED and other lighting devices. Further development of FIPEL technology results in flexible and rigid panels where complex surfaces may contain the new lighting allowing replacement of device housings as well as construction of arrays of panels allowing replacement of pixel based display screens.

### SUMMARY

Outer surfaces of housing used to contain such things as consumer electronics assemblies, non-electronic assemblies such as clothing and other passive devices and surfaces found on such things as vehicles, aircraft, appliances and other devices that have color or surface designs that are static. Products are released every year that are identical to previous releases with the exception of surface color or patterns. Other products are released where they have displays on their surface where a new release only has an updated display capable of displaying new data associated with the product. The inventor recognized that these practices result in products having very short usable life spans.

The inventor recognized that what is needed is a way to change the surface color or patterns of product housings as well as making the entire surface of a product an active matrix of light emissive elements where not only the surface of the product is changeable but displays on the surface of the product can be changed at will by the user; or by updated software or firmware loaded into the product by the manufacturer or the user.

This, for the first time, creates a system where firmware/software updates not only change the function of the product, but also change the look of the product.

### BRIEF DESCRIPTION OF THE DRAWINGS

in the drawings:

FIG. 1 is a depiction of an asymmetrical (single dielectric layer) FIPEL device that emits light from one surface.

FIG. 2 is a depiction of an asymmetrical (single dielectric layer) FIPEL device that emits light from two surfaces.

FIG. 3 is a depiction of a symmetrical (two dielectric layers) FIPEL device that emits light from one surface.

FIG. 4 is a depiction of a symmetrical (two dielectric layers) FIPEL device that emits light from two surfaces.

FIG. 5 is a depiction of the CIE color index with a triangle bounding the colors that are specified by the NTSC standard for television.

FIGS. 6A and 6B are a depictions of two simple shapes that a FIPEL panel may be formed into and shown with overshot material to improve the structural integrity.

FIGS. 7A, 7B and 7C are depictions of a device whose surfaces have been covered or wrapped with a FIPEL panel(s).

FIG. 8 is a depiction of a FIPEL panel that emits light in two directions where the color of light emitted from each surface may be a different color.

### DETAILED DESCRIPTION

The present invention uses a lighting technology called Field Induced Polymer ElectroLumuinescence, referred to as FIPEL lighting.

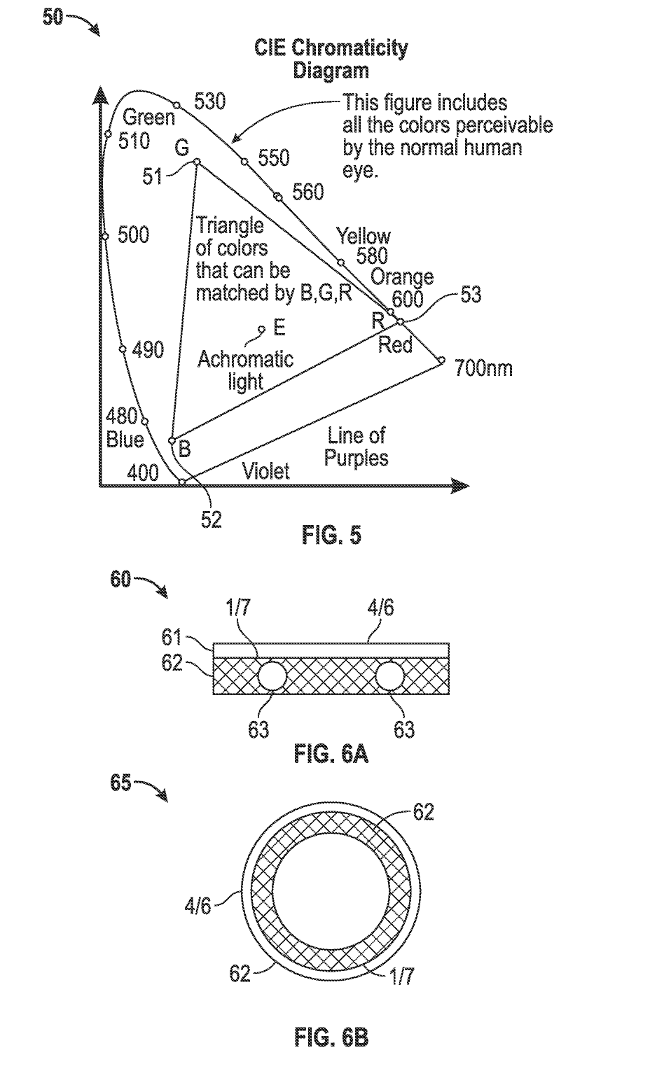

FIG. 5, the CIE color chart, is taken from a website located at:

(http://hyperphysics.phy-astr.gsu.edu/% E2%80%8Chbase/vision/cie.html)

FIG. 5 is a replication of the CIE color index chart. Note that 51, 52 and 53 are points to the vertices Green (51), Blue (52) and Red (53). The three X,Y coordinates for a triangle that is the color space used for NTSC defined color.

FIPEL panels have the distinguishing feature of being able to emit colored light from any point on the CIE index bound by the triangle shown in FIG. 5 which contains the colors displayable on a color television displaying NTSC standard colors. The present invention makes use of this feature of FIPEL light panels by giving users and designers the ability to select specific colors they desire as well as the ability to construct flexible panels. This gives designers the ability to deliver products that may extend the usable life of the product by allowing the product to have a housing or other part that can change in color.

In many of the embodiments disclosed below, the FIPEL panels may have a display surface that is wrapped or molded to the surface of a housing or may after being molded to a surface be coated or overshot with material on the back surface such that the panel becomes the structural housing as well as a display surface.

In one embodiment of the invention, a product housing with simple and complex curves may have an outer surface of FIPEL material. The FIPEL material may present a predetermined static color when the device is in an unpowered state but may have any color surface defined on the CIE color chart when the device is connected to power.

In another embodiment of the invention, the outer surface of a device may be a matrix of FIPEL panels that can be as small as a pixel on a high definition television. In this embodiment, the device may contain displays and alerts on the surface made up of pixel sized FIPEL panels. These displays may display data such as pictures, messages, indications and alerts. The ability of an electronic device covered under this embodiment may be able to alert the user to environmental and other emergencies.

In another embodiment of the invention, flexible FIPEL panels may be integrated into the fabric of apparel such as vests worn by emergency personnel. In this embodiment, the integrated FIPEL panels may emit different colors and patterns of light to warn citizens of hazardous conditions.

In another similar embodiment of the invention, flexible FIPEL panels or a FIPEL matrix integrated into apparel such as hats, jackets, pants, hand bags, back packs, shoes, and other wearable garments may allow the user to alter not only the color but static and moving animations and patterns of the apparel.

In another embodiment of the invention, FIPEL panels and or a FIPEL matrix may be integrated into the surface of automobile panels where the FIPEL panels become part of the bumper surface or a panel on the back of the vehicle such as the trunk or door surface. In this embodiment the entire bumper/door/trunk lid may emit large volumes of light in specific directions as a safety feature which may include messages such as “STOP” or “HELP”. If integrated into emergency vehicles such as police vehicles the matrix panel may emit messages as warnings.

In another embodiment of the invention, the housing of a television may be composed of multiple FIPEL panels where some surfaces of the housing may display messages while another surface of the housing may display a backlight that provides lighting to the back wall where a television is located thus reducing the contrast of the television screen and a dark area behind the television.

In another embodiment of the invention, the housing of device may be used to display lighting to provide area lighting.

An embodiment uses a light emitting surface device that may contain a plurality of light emitting elements referred to as Field-Induced Polymer ElectroLuminescent devices. The invention is intended for wrapping or being the actual housing surface that can display colors, patterns or present animated displays. Embodiments use FIPEL panels where the light emissive element may be a single element or a plurality of elements where the size of a single element may be the size of the surface being covered or the size of a pixel typically found on a high definition television display and a signal generator that provides an alternating power source to the emissive elements of the invention whereby the frequency of the alternating power determines the color of the emitted light.

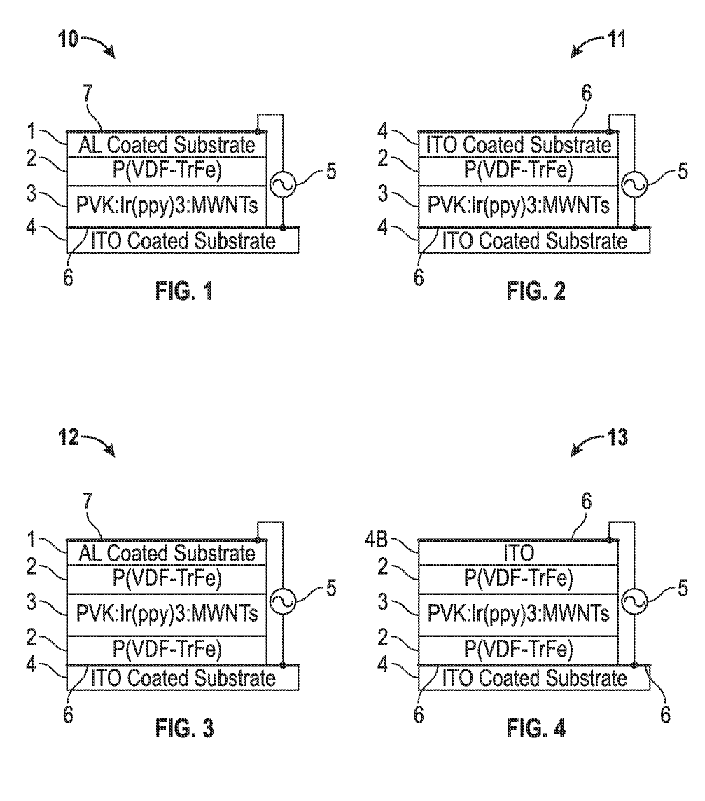

To appreciate the simplicity of FIPEL devices, reference FIGS. 1 and 2.

FIGS. 1 and 2 illustrate single dielectric FIPEL devices. The basic construction of these FIPEL devices is discussed in the following.

Lab quality FIPEL devices are generally fabricated on glass or suitable plastic substrates with various coatings such as aluminum and Indium tin oxide (ITO). ITO is a widely used transparent conducting oxide because of its two chief properties, it is electrical conductive and optical transparent, as well as the ease with which it can be deposited as a thin film onto substrates. Because of this, ITO is used for conducting traces on the substrates of most LCD display screens. As with all transparent conducting films, a compromise must be made between conductivity and transparency, since increasing the thickness increases the concentration of charge carriers which in turn increases the material's conductivity, but decreases its transparency. The ITO coating used for the lab devices discussed here is approximately 100 nm in thickness. In FIG. 1, emissive side substrate 4 is coated with ITO coating 6 residing against PVK layer 3. In FIG. 2, ITO coating 6 is on both substrates as shown.

Substrate 1 in FIGS. 1 and 3 is coated with aluminum (AL) coating 7. The resulting thickness of the AL deposition is sufficient to be optically opaque and reflective. This ensures that any light from emissive layer 3 that travels toward substrate 1 is reflected and directed back through emissive substrate 4 with ITO coating 6 for devices illustrated in FIG. 1. If it is desired that light be emitted through both substrates, a substrate 4 with an ITO coating 6 will be substituted for substrate 1 with AL coating 7 as shown in FIG. 2.

The differences between the two similar substrates is how ITO coating 6 is positioned. In FIG. 1, emissive ITO coating 6 is positioned such that ITO coating 6 on substrate 4 is physically in contact with PVK layer 3. In FIG. 2, substrate 1 with Al coating 7 (FIG. 1) is replaced with substrate 4 with ITO coating 6 not in physical contact with the P(VDF-TrFe) (dielectric layer) layer 2. This allows light to be emitted from both the top and bottom surfaces of the FIPEL device.

Dielectric layer 2 in all cases is composed of a copolymer of P(VDF-TrFE) (51/49%). The dielectric layer is generally spin coated against the non-AL coated 7 side of substrate 1 or non-ITO coated 6 of substrate 4 of the top layer (insulated side). In all cases the dielectric layer is approximately 1,200 nm thick.

Emissive layer 3 is composed of a mix polymer base of poly(N-vinylcarbazole):fac-tris(2-phenylpyri-dine)iridium(III) [PVK:Ir(ppy)3] with Medium Walled Nano Tubes (MWNT). The emissive layer coating is laid onto the dielectric layer to a depth of approximately 200 nm. For the lab devices with the greatest light output the concentration of MWNTs to the polymer mix is approximately 0.04% by weight.

When an alternating current is applied across the devices shown in FIGS. 1 and 2 (asymmetrical devices containing 1 dielectric layer) the emissive layer emits light at specific wavelengths depending on the frequency of the alternating current. The alternating current is applied across the conductive side of the top substrate 1 (Al coating 7) or substrate 4 and the conductive side (ITO coating 6) of bottom substrate 4. Light emission comes from the injection of electrons and holes into the emissive layer. Holes follow the PVK paths in the mixed emissive polymer and electrons follow the MWNTs paths.

Carriers within the emissive layer then recombine to form excitons, which are a bound state of an electron and hole that are attracted to each other by the electrostatic force or field in the PVK host polymer, and are subsequently transferred to the Ir(ppy)3 guest, leading to the light emission.

The frequency of the alternating current applied across the substrates of the FIPEL panel can also determine the color of light emitted by the panel. Any index on the CIE chart can be duplicated by selecting the frequency of the alternating current. Signal generator 5 may be of a fixed frequency which is set by electronic components or signal generator 5 may be controlled by a microprocessor executing algorithms that determine the frequency of signal generator 5 based on stimuli.

Aluminum coating 7 may also be any reflective and conductive coating such as but not limited to tin, nickel or other conductive and reflective coatings.

ITO coating 6 may be any conductive and transparent material such as, but not limited to graphene or ITO.

Now referencing FIG. 6A where 60 depicts a flat panel type of FIPEL device. In this depiction 61 is the panel as previously shown in FIG. 1 where 1/7 is the back reflecting non-emissive surface of the device and 4/6 is the front emissive surface of the device. Likewise, FIG. 6B shows a FIPEL device that may be bent, flexed or molded into a tube like shape. In this depiction, 62 is the device, 1/7 is the back reflecting non-emissive surface of the device and 4/6 is the front emissive surface of the device. FIG. 6A also shows a structure 62 which is additional material that may be bonded or sprayed onto the back or reflective layer of FIPEL panel 61. Note that in this depiction there are holes 63 in overshot material 62 for the possible purpose of attachment points or through holes for other purposes such as cooling. Likewise FIG. 6B shows overshot material 62 added to FIPEL panel 61 to improve structural integrity of FIPEL panel 61.

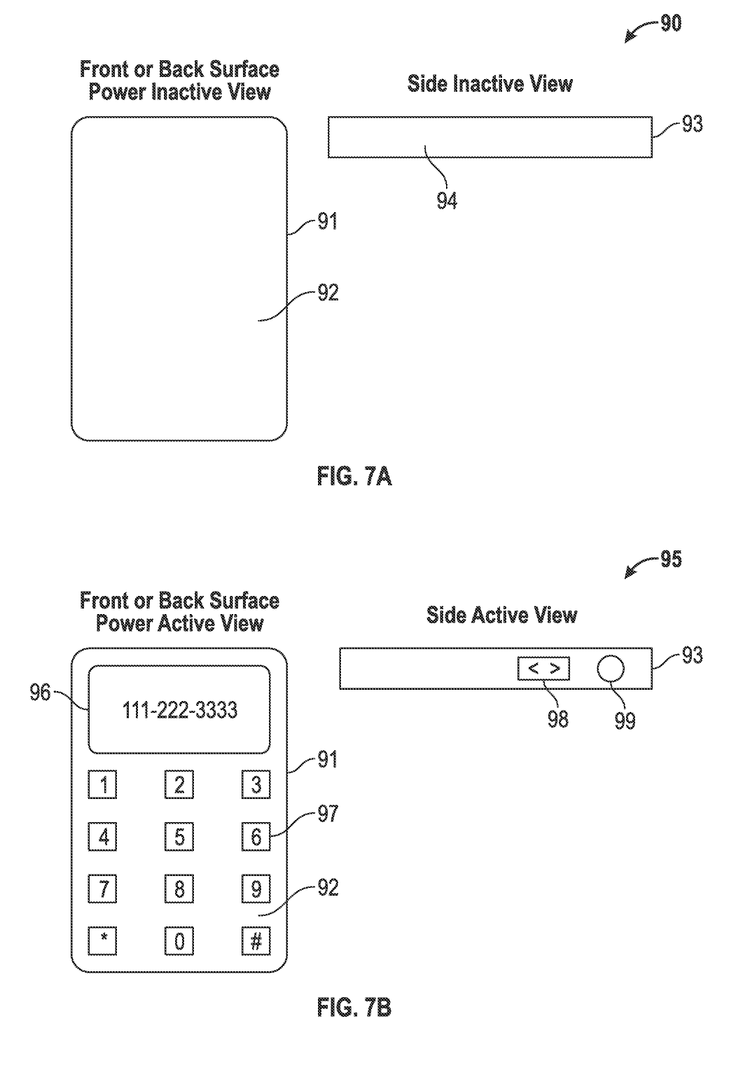

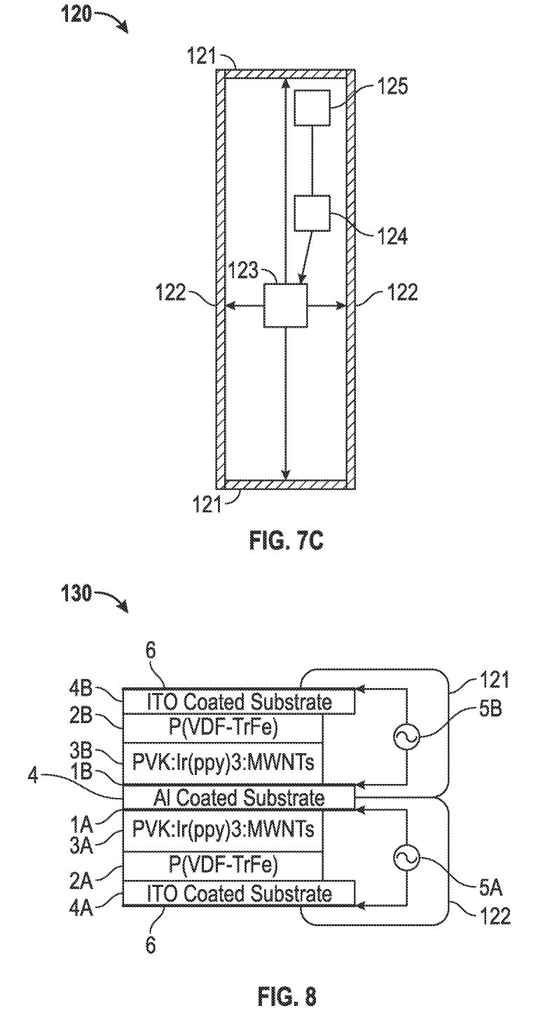

Now referencing FIGS. 7A, 7B and 7C. In these depictions a FIPEL wrapped device such as a cell phone is shown. FIG. 7A depicts 90 with a front view and a side view showing the handheld device such as a cell phone in an unpowered state or a state where the displays are blank. In this depiction 91 is the device with front surface 92 and side surface 93 showing that the surfaces are all blank because the device is in a standby or non-powered state.

FIG. 7B depicts FIPEL device 91 in a powered state. Note that in this depiction former blank surface 92 now contains visible objects 96 which is a phone number and caller ID window and 12 button objects 97 which in this depiction are dial buttons. Likewise, FIG. 7B shows side view 93 which now shows an emulation of a rocker switch 98 which appears as a typical volume control on a cell phone, PDA or portable media player and mode button 99 which would typically control on and off states.

In this depiction, device 91 would be wrapped in a FIPEL active matrix (pixel) material or be covered with FIPEL panels on the front, back and two side edges. In some embodiments the top and bottom edges of the illustrated device would also be covered with FIPEL panels for displaying information or color. Regardless of orientation the front or back flat surface will display a cell phone face when the device is touched or moved and the visible side in FIG. 7B will display the rocker switch and mode button.

FIG. 7C is a depiction of the FIPEL panels and control logic not visible in FIG. 7A or 7B. In FIG. 7C 120 depicts FIPEL pixel panel arrays and the logic necessary to manage the matrixes. In this depiction front and back FIPEL pixel panel arrays 121 depicts the two arrays for the sides of the cell phone. FIPEL pixel panel arrays 122 depicts the front and back surfaces of the cell phone. In this depiction 123 depicts the row and column addressing multiplexor which controls the on/off/color state of each pixel on each FIPEL pixel panel. Object 125 is a position orientation sensor which sends signals to microprocessor 124 informing microprocessor 124 when device 120 has been moved and what the current orientation is. Microprocessor 124 sends signals consisting of control signals and image signals to row and column addressing multiplexor 123 directing row and column addressing multiplexor 123 when to display images and the surfaces to display them on.

The microprocessor 124 also receives and coordinates the updates of software/firmware as received either wirelessly or some other way. The firmware updates can update the operating software, and can also update the way that the housing looks after the update by changing the driving of the panels. This can change the color of the housing, the position or color of the ‘soft’ buttons or the like.

Now referencing FIG. 8, 130 is a diagram of a FIPEL panel where light may be emitted from both the front and back surfaces and the light from each surface may be a different color. In this depiction, 121 and 122 depict two similar FIPEL panels with a common reflective substrate 4. In this depiction FIPEL panel 121 is comprised of emissive substrate 4B/6 where 6 is an optically transparent ITO coating on substrate 4. Substrate 4B/6 is physically bonded to dielectric layer 2B. Substrate 4 with reflective coating 1B is the conductive coating that is in direction physical contact with emissive layer 3B and conducts current from signal generator 5B to emissive layer 3B.

FIPEL panel 122 is identical to FIPEL panel 121 and shares substrate 4 with FIPEL panel 121.

This configuration allows a FIPEL device to emit different colors from both the front and back surfaces. This becomes useful when a FIPEL panel is overshot with structural material that is transparent for the housing of the device such as a multimedia player or television. In this embodiment the front display panel may be a FIPEL pixel array (for example, FIPEL panel 122) and the back surface may be a single panel (for example, FIPEL panel 121) where the front surface is displaying a video and the back surface is displaying colored light.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, other Category Devices that can be used according to this system can include the following.

Consumer Electronic Devices Mobile phones, cameras, PDAs, portable multimedia players, desktop and laptop computers, tablet computers.

Kitchen Appliances Mixers, stove/oven/range tops, refrigerator housings, mixers, blenders, toasters other powered and non-powered appliances.

Tools Portable handheld powered tools, surveyor equipment, powered shop saws, planers, and other tools typically used in craft trades.

Vehicle Surfaces Automobiles, trucks, boat and ships, aircraft for such things as interior instrument displays, exterior front and rear lighting displays such as head lights, marker lights, running lights, brake lights, turn signals and displays on exterior surfaces.

Apparel Civilian clothing, sports apparel and uniforms where the FIPEL display may be a single panel or a pixel based display woven into the fabric of the apparel.

Aircraft Flat and complex curved surfaces found on aircraft such as instrument panels, cabin lighting, warning displays and other types of displays on both interior and exterior surfaces.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An electronic device, comprising:
a housing having at least one curved surface;
an electronic device, in said housing;
said electronic device carrying out a function and displaying information about said function that can be seen via said housing;
said housing having a controllable color portion on said at least one curved surface; and
said electronic device controlling said controllable color portion to display its color.

2. The device as in claim 1, wherein said controllable color portion is a field induced polymer electroluminescence panel.

3. The device as in claim 1, wherein said electronic device obtains a software update to change its function, and where said software update also changes said controllable color portion.

4. The device as in claim 1, wherein said controllable color portion includes an overshot structural portion.

5. The device as in claim 1, wherein said controllable color portion includes a first portion which emits a first colored light in a first direction towards a front of the device, and a second color portion which emits a second colored light in a second direction towards a back of the device.

6. The device as in claim 5, wherein said first and second color portions include a common reflective substrate between first and second stacks of materials.

7. The device as in claim 1, wherein said electronic device is portable.

8. The device as in claim 7, wherein said electronic device is a cellular phone.

9. The device as in claim 7, wherein the portable device, when unpowered, has no permanent markings thereon, and is operated to create markings using said controllable color portion to create areas that have different colors to show markings thereon.

10. The device as in claim 9, wherein said markings include buttons to control functions of the device.

11. The device as in claim 1, wherein in entirety of the electronic device is controlled to have a same color.

12. A device as in claim 1, wherein the electronic device is one of a Consumer Electronic Devices including Mobile phones, cameras, PDAs, portable multimedia players, desktop and laptop computers, tablet computers, or Kitchen Appliances, Mixers, stove/oven/range tops, refrigerator housings, mixers, blenders, toasters, or Tools such as Portable handheld powered tools, surveyor equipment, powered shop saws, planers, and other tools typically used in craft trades or Vehicle Surfaces such as Automobiles, trucks, boat and ships, aircraft for such things as interior instrument displays, exterior front and rear lighting displays such as head lights, marker lights, running lights, brake lights, turn signals and displays on exterior surfaces or Apparel such as Civilian clothing, sports apparel and uniforms which may be a single panel or a pixel based display woven into fabric of the apparel, or Aircraft such as Flat and complex curved surfaces found on aircraft such as instrument panels, cabin lighting, warning displays and other types of displays on both interior and exterior surfaces.

13. An electronic device, comprising:
a housing holding an electronic device, and having an outer surface formed of color-controllable electroluminescent material, a color of said housing controlled by said electronic device,
where the color-controllable electroluminescent material has a predetermined static color when the device is in an unpowered state and is controlled to any color among those defined on a CIE color chart when the device is connected to power.

14. The device as in claim 13, wherein said color-controllable electroluminescent material is a field induced polymer electroluminescence panel.

15. The device as in claim 13, wherein said electronic device obtains a software update to change its function, and where said software update also changes said color-controllable electroluminescent material.

16. The device as in claim 13, wherein said color-controllable electroluminescent material includes a first portion which emits a first colored light in a first direction towards a front to control said color of said housing, and a second color portion which emits a second colored light towards a back.

17. The device as in claim 16, wherein said first and second color portions include a common reflective substrate between first and second stacks of materials.

18. The device as in claim 13, wherein said electronic device is portable.

19. The device as in claim 18, wherein the portable device, when unpowered, has no permanent markings thereon, and is operated to create markings using said color-controllable electroluminescent material to create areas that have different colors to show markings thereon.

20. The device as in claim 19, wherein said markings include buttons to control functions of the device.

21. The device as in claim 13, wherein an entirety of the electronic device is controlled to have a same color.

22. A device as in claim 13, wherein the wherein the electronic device is one of a Consumer Electronic Devices including Mobile phones, cameras, PDAs, portable multimedia players, desktop and laptop computers, tablet computers, or Kitchen Appliances, Mixers, stove/oven/range tops, refrigerator housings, mixers, blenders, toasters, or tools such as Portable handheld powered tools, surveyor equipment, powered shop saws, planers, and other tools typically used in craft trades or Vehicle Surfaces such as Automobiles, trucks, boat and ships, aircraft for such things as interior instrument displays, exterior front and rear lighting displays such as head lights, marker lights, running lights, brake lights, turn signals and displays on exterior surfaces or Apparel such as Civilian clothing, sports apparel and uniforms which may be a single panel or a pixel based display woven into a fabric of the apparel, or Aircraft such as Flat and complex curved surfaces found on aircraft such as instrument panels, cabin lighting, warning displays and other types of displays on both interior and exterior surfaces.

23. A method of controlling an electronic device, comprising:
using an electronic part in a housing to carry out a function and display information about said function that can be seen via said housing;
controlling said color-controllable electroluminescent material to display its color to change a color of the housing.

24. The method as in claim 23, wherein said color-controllable electroluminescent material is a field induced polymer electroluminescence panel.

25. The method as in claim 23, wherein said electronic device obtains a software update to change its function, and where said software update also changes the color of the housing.

26. The method as in claim 23, wherein said electronic device is portable.

27. The method as in claim 26, wherein the portable device, when unpowered, has no permanent markings thereon, and further comprising operating the portable method to create markings using said controllable color portion to create areas that have different colors to show markings thereon.

28. The method as in claim 27, wherein said markings include buttons to control functions of the device.

29. The method as in claim 23, wherein an entirety of the electronic device is controlled to have a same color.

30. A method as in claim 23, wherein the electronic device is one of a Consumer Electronic Devices including Mobile phones, cameras, PDAs, portable multimedia players, desktop and laptop computers, tablet computers, or Kitchen Appliances, Mixers, stove/oven/range tops, refrigerator housings, mixers, blenders, toasters, or Tools, such as Portable handheld powered tools, surveyor equipment, powered shop saws, planers, and other tools typically used in craft trades or Vehicle Surfaces, such as Automobiles, trucks, boat and ships, aircraft for such things as interior instrument displays, exterior front and rear lighting displays such as head lights, marker lights, running lights, brake lights, turn signals and displays on exterior surfaces or Apparel such as Civilian clothing, sports apparel and uniforms where the FIPEL display may be a single panel or a pixel based display woven into the fabric of the apparel or Aircraft such as Flat and complex curved surfaces found on aircraft such as instrument panels, cabin lighting, warning displays and other types of displays on both interior and exterior surfaces.
